(19) United States
(12) Patent Application Publication
(10) Pub. No.: US 2006/0216989 A1
(43) Pub. Date: Sep. 28, 2006

(54) Plug or connector of a plug-type connection for motor-vehicle use

(75) Inventors: Thomas Burk, Bad Liebenzell (DE); Dagmar Dirnbauer, Dalaas (AT)

Correspondence Address: THE FIRM OF KARL F ROSS, 5676 RIVERDALE AVENUE, PO BOX 900, RIVERDALE (BRONX), NY, 10471-0900, US

(73) Assignee: Hirschmann Automotive GmbH

(21) Appl. No.: 11/369,209

(22) Filed: Mar. 6, 2006

(30) Foreign Application Priority Data
Mar. 5, 2005 (DE) 102005010217.4
Sep. 1, 2005 (DE) 102005041471.0

(51) Int. Cl. H01R 13/40

(52) U.S. Cl. 439/587

(57) ABSTRACT

Plug or coupler of a plug connector to be used in vehicles The invention relates to a plug or coupler of a plug connector to be used in vehicles, wherein the plug or coupler has a housing (2) for the reception of several complementary contact elements, wherein the complementary contact elements are at least once latched in the housing (2), wherein the invention provides that a contact carrier (1) can be sealingly inserted in the housing (2) for the reception of the complementary contact elements and the contact carrier (1) has means for the latching of the contact partners within the contact carrier (1).

The invention relates to a plug or coupler of a plug connector to be used in vehicles according to the preamble of claim 1.

From DE 41 24 541 A1 an electric plug connector element is known, in the seat of which elastically pivotable latch arms for the latching of inserted plug contact elements (complementary contact elements). The latch arms are molded on a housing wall and, for latching, come to lie with their free end at a ledge of the corresponding plug contact elements. For a secure latching, a spacer block is inserted into the inner area of the plug connector component from the mating side. In a first position the block allows an elastic pivoting of the latching arm and in a second position blocks the pivoting of the latch arms. When a plug contact element is to be removed again from its seat the spacer block has to be brought back to its initial position, only then a tool can be inserted into the inner area of the plug connector component for the pivoting of the latching arm and the plug contact element concerned can be removed from its seat. Due to completely missing means on the housing and the plug contact, only one kind of latching of the plug contact elements can be carried out by means of such a plug connector component. Several work steps are necessary in order to release this latching that refers to one kind of latching method only.

In addition, DE41 24 541 A1 does not include any sealing means for a longitudinal sealing of the electric plug connector component.

A further electric plug connector component is known from DE 43 01 602 C1. In the case of this electric plug connector component the electric plug contact elements are inserted into seats of the housing provided with one latching arm for each seat.

For the so-called secondary latch each latching arm can be moved from a unlocking into an latching position. Furthermore, each of the electronic plug contact elements is provided with two molded spring arms that come to lie behind walls of the catch lugs molded on the corresponding seats, thus the electric plug contact elements within the seats are primarily locked. When an electronic plug contact element is to be removed from its seat, a tool is inserted using corresponding access openings into the coordinated seat that leads to a release of the primary lock. In order to remove the plug contact element from its seat the secondary latch has to be released in a further work step. DE 43 01 602 C1 does not include means for a longitudinal sealing of the plug connector component.

From DE 44 33 617 C2 a further development of the plug connector component of DE 41 24 541 A1 is known. The plug connector component in DE 44 33 617 C2 has a reset cam face molded to the end areas of each latching arm and the housing has at least one further access per seat, starting at the mouth area of the housing and basically extending parallel to the longitudinal direction of the seat. Thus the tool is can be inserted in the housing not only over the two accesses but as well over a further access and thereby abuts the reset cam face and moves the latching arm by an extended inserting movement from its latching into its unlocking position.

Thus the three patents described before prove that the plug contact elements can be primarily and secondarily locked within the housing of the plug connector component. This way at least the latching of the plug contact elements in the plug connector component is achievd in a satisfactory manner, the longitudinal sealing of the plug connector component, however, is not, in particular if a plug connector component is a plug, a further plug connector component is a coupler, which can be plugged together and the plug connector is to be used in a vehicle. Particularly if used in vehicles, as aimed at by the present patent application, sealing of the plugged plug connector is of particular importance in order to ensure longitudinal water-tightness. This longitudinal water-tightness means that neither water (particularly splash water), nor humidity nor other impurities (like e.g. dirt particles) can infiltrate the contact area neither over the area in which a cable or several cables is/are inserted in the housing of the plug or of the coupler, nor over the area in which plug and coupler are plugged together. Therefore it is of particular importance, as far as the application of such plugs and couplers to vehicles is concerned, that the contact area of the complementary contact elements of the plug and of the coupler that are used in vehicles cannnot be penetrated by water, humidity and other dirt particles after the plugging. At the same time the plug connector consisting of a plug and coupler should be extremely mechanically resistant, especially as far as vibrations and other exterior mechanical influences encountered in vehicles are concerned.

In prior art the mechanical resistance to exterior influences is satisfyingly solved thanks to the primary and secondary latch, in DE 44 33 617 C2, however, in a very complicated way. The problem regarding the longitudinal water-tightness was not recognized at all in the prior art described before and therefore no solution was proposed in this regard.

It is therefore the object of the invention to create a plug or a coupler of a plug connector to be used in vehicles, which is resistant to the mechanical influences encountered in a vehicle, like e.g. vibrations, but which simultaneously has the tightness necessary to avoid a penetration of water, humidity or other dirt particles into the contact are of the plug connector with a high installation safety and as simple as possible a design.

This object is attained by the characteristics of claim 1.

The invention provides that the housing of the plug or coupler has a contact carrier that can receive the complementary contact elements, can be used for sealing and has means for latching the complementary contact elements within the contact carrier. The means for latching the complementary contact elements within the contact carrier have the effect that the respective complementary contact element can be efficiently fixed within the contact carrier so that the necessary mechanical stability for the use in vehicles is achieved. Among the latching means are for example catch means, like e.g. an elastic ledge on the complementary contact element that abuts a recess or a section of the contact carrier. Such latching means both for primary latching and/or for secondary latching are known, the means of the respective complementary contact element, however, do not interact with a contact carrier (as provided by the invention), but with the housing of the plug or of the coupler. By providing an interaction of the latching means according to the invention, the contact carrier can be completely synchronized to the latching, while the housing does not have to receive this latching means, hence more constructive liberties are possible. Thereby the advantage is gained that plugs and corresponding mating plugs (that is plugs and sockets [also called couplers] with the same geometries in the plugging area, can have-different geometries in the receiving area of the complementary contact elements (contact chambers) so that different complementary contact elements can be used according to the application but the geometry of the housing of the plug or respectively the coupler is maintained. Alternatively, different contact carriers can be used for different complementary contact elements. Also, the geometry of the housing advantageously remains unmodified. As a further advantage of this embodiment it is possible to obtain additional coding variants, for instance by turning the contact carrier 180°, without causing further tool costs.

In order to achieve the necessary longitudinal water tightness, i.e. generally the tightness of the plug connector in longitudinal direction, the contact carrier is sealingly inserted in the housing of the plug or coupler. Thus one variant of the invention provides sealing means in the inner are of the housing and/or the contact carrier. That means that a separate sealing element (for example an O-shaped ring) that seals the gap between the inner are of the housing and the contact carrier is inserted into a groove surrounding the housing or the contact carrier. A further alternative is to provide the sealing means while the contact carrier is produced and/or while the housing is produced, which can possibly be carried out by additionally spraying-on of sealing material or by means of a multicomponent procedure. This is particularly useful when housing and contact carrier are produced by means of a plastic injection-molding procedure. As a further alternative sealing means are provided between the contact carrier and the inner area of the housing and/or between a mating connector and the inner area of the housing, i.e. the sealing means are a separate component inserted into the housing while the contact carrier is installed.

In a further embodiment of the invention the contact carrier and/or the inner are of the housing have guiding means for the insertion of the contact carrier within the inner area of the housing. This ensures that the contact carrier is inserted into the housing in a target-oriented manner and in the right position, for which the guiding means were designed for so that the contact carrier can easily and in a target-orientated way be inserted into the housing. In addition to these advantages, the whole plug housing is stabilized, in particular if the guiding means are formed like bars. Thereby the whole plug or respectively coupler becomes significantly more robust. Thereby especially the high demands regarding resistance to vibrations in the automobile industry are fulfilled.

In a further embodiment of the invention the contact carrier can be positively or non-positively fixed within the housing, wherein the sealing occurs contemporaneously to this fixing. That means that the contact carrier is connected to the housing (also called protection collar) with the help of the sealing means (e.g. a sealing contour). In order to achieve a non-positive locking the contact carrier and/or the housing is/are provided with catch means so that for example the contact carrier has at least one catching hook that connects to a corresponding section or recess in the inner area of the housing (or vice-versa). Alternatively or complementary to the fixing of the contact carrier in the housing by means of adhesion a non-positive locking can be achieved, for example by welding, gluing or suchlike.

The design of the plug or the coupler according to the invention with housing and contact carrier arranged within is advantageous since the complementary contact elements can be equipped without the actuation of additional latching elements. Moreover, on the housing such unlocking elements (protection collar) can be avoided, so that it can be closed almost completely or even completely and therefore, when the plug connector is plugged together the best possible protection against exterior influences is ensured. In other words that means that the protection color is completely closed, with the exception of a little opening due to the tool design and thus the sealing protection is very good. Additionally, the housings of the plug and of the coupler can be provided with further latching means that bring about that plug and coupler after being plugged together cannot be separated without additional effort or use of tools.

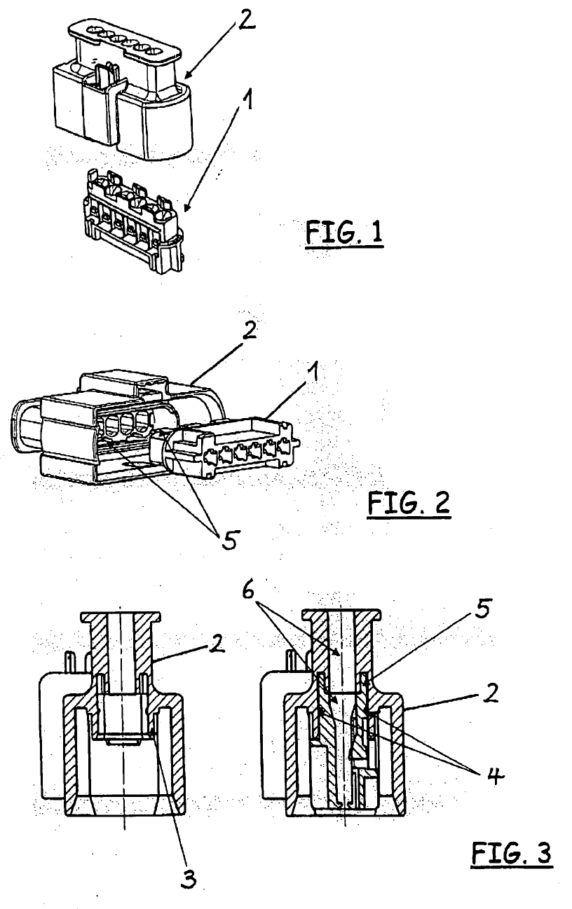

One embodiment of the invention, in no way limiting, is illustrated in FIGS. 1 to 3 and described in the following.

As far as illustrated in detail, FIG. 1 shows a contact carrier 1 of a plug or a coupler, wherein the contact carrier 1 was e.g. produced in a plastic injection molding procedure. It has several chambers into which the complementary contact elements can be inserted. The complementary contact partners are latched in their corresponding chambers with the help of common and known means and are therefore protected from mechanical unhinging movements. Furthermore a housing 2 (also called protection collar) interacting with a contact carrier 1 is shown. It has openings for leading through items, especially for sealingly leading through cables that correspond in number to the contact chambers.

FIGS. 2 and 3 show in a three-dimensional view (FIG. 2) and in two sectional views (FIG. 3) further embodiments of the plug or coupler according to the invention. In FIG. 3 (on the left) is illustrated a sealing area 3, in which sealing means are arranged (not illustrated) causing a sealing between the housing 2 and a not illustrated mating connector. Furthermore FIG. 3 (right illustration) shows a catch area 4 (catching) where the contact carrier 1 can be positively fixed to the housing 2. For the stabilization as well as for the installation-friendly and safe insertion of the contact carrier 1 in the inner area of the housing 2 the contact carrier 1 and/or the housing 2 have a guiding area 5 that can for instance be a bar (at the contact carrier 1) with a corresponding groove (at the inner area of the housing 2).

FIG. 3, right illustration, additionally shows that the contact carrier 1 has one latching arm per contact chamber, by means of which the complementary contact element therein inserted is secondarily locked.

The production and installation of the plug or respectively of the coupler can for example be carried out as follows:

At first the contact carrier 1 and housing 2 are produced by means of a plastic injection-molding procedure. Electric conductors, especially stranded wires, are contemporaneously prepared, wherein the respective ends of the conductors are led through the openings of the housing 2. Subsequently they are insulated at their ends and the complementary contact elements are mounted in the insulated area, for example by means of a crimp connector. After that, the complementary contact elements are inserted in the corresponding contact chambers of the contact carrier 1 and the contact carrier 1 thus prepared is connected to the housing 2 so that the contact carrier 1 is sealingly fixed to the housing 2. Subsequently the cable can be sealed against the housing 2 in the areas of the housing 2 that do not face the complementary contact elements.

Alternatively to the installation procedure described before it is also possible that the contact carrier 1, with its latching means for the complementary contact elements and/or its fixing, is fixed within the housing 2 and that the ends of the cables (with complementary contact elements that are electrically contacted there) are inserted into the respective contact chambers (of the housing 2 or respectively of the contact carrier 1) through the openings in the housing 2. Thereby the exterior coatings of the respective conductors are sealed as well against the housing 2 by adequate sealing means, for example sealing covers.

### LIST OF REFERENCE SIGNS

contact carrier
housing (protection collar)
sealing area
catch area
guiding area
contact chamber

1. A plug or coupler of a plug connector to be used in vehicles, wherein the plug or coupler has a housing (2) for the reception of several complementary contact elements, wherein the complementary contact elements are at least once latched in the housing (2), characterized in that a contact carrier (1) for the reception of the complementary contact elements can be sealingly inserted in the housing (2) and that the contact carrier (1) has means for latching the complementary contact elements within the contact carrier (1).

2. The plug or coupler according to claim 1 characterized in that the inner area of the housing (2) and/or the contact carrier (1) are provided with sealing means.

3. The plug or coupler according to claim 1 characterized in that sealing means are provided between a mating connector and the inner area of the housing (2).

4. The plug or coupler according to one of the preceding claims characterized in that the contact carrier (1) and/or the inner area of the housing (2) have guiding means for the insertion of the contact carrier (1) in the inner are of the housing (2).

5. The plug or coupler according to one of the preceding claims characterized in that the contact carrier (1) can be positively and/or non-positively fixed within the housing (2).

6. The plug or coupler according to claim 5 characterized in that the contact carrier (1) and/or the housing (2) are provided with catch means for the achievement of a non-positive locking.
